(19) United States
(12) Patent Application Publication
(10) Pub. No.: US 2005/0202872 A1
(43) Pub. Date: Sep. 15, 2005

(54) Game data and speech transfer to and from wireless portable game terminal

(76) Inventor: Kari Niemela, Oulu (FI)

Correspondence Address: CRAWFORD MAUNU PLLC, 1270 NORTHLAND DRIVE, SUITE 390, ST. PAUL, MN, 55120, US

(21) Appl. No.: 10/797,953

(22) Filed: Mar. 11, 2004

(51) Int. Cl. A63F 9/24; A63F 13/00; G06F 19/00

(52) U.S. Cl. 463/40

(57) ABSTRACT

Game data and speech transfer to and from a wireless portable game terminal is disclosed. The wireless portable game terminal includes a radio transceiver configured to transfer speech and game data through a radio connection to a telecommunication system, a loudspeaker, a microphone, and a processing unit. The processing unit is configured to process the game data, to transfer the game data to and from another game terminal or a game server through the radio connection, to receive captured speech of another user through the radio connection, to output audio part of the game data and the captured speech of the other user through the loudspeaker, to capture speech of an user with the microphone, and to transfer the captured speech of the user to another game terminal or to a game server through the radio connection.

### FIELD

The invention relates to a wireless portable game terminal, a method for transferring speech and game data to and from a wireless portable game terminal through a radio connection to a telecommunication system, a computer program product encoding a computer process for transferring speech and game data to and from a wireless portable game terminal through a radio connection to a telecommunication system, and a network element of a telecommunication system.

### BACKGROUND

The use of wireless portable game terminals is currently spreading. A game refers to electronic entertainment games. The term ‘video game’ may also be used. Wireless portable game terminals may be normal subscriber terminals, or then they may be terminals especially adapted for gaming purposes, such as Nokia® N-Gage™ game deck.

Besides stand-alone games, network games may also be played with wireless portable game terminals. When playing a network game, game data and speech of a player may have to be transferred to and from another game terminal or a game server.

The existing transfer means, such as EGPRS (Enhanced General Packet Radio Service), may have too long transfer delays, which makes real-time network gaming practically impossible. One-way transfer delays may be in the order of 500 milliseconds.

### BRIEF DESCRIPTION OF THE INVENTION

The present invention seeks to provide an improved wireless portable game terminal, an improved method for transferring speech and game data to and from a wireless portable game terminal through a radio connection to a telecommunication system, an improved computer program product encoding a computer process for transferring speech and game data to and from a wireless portable game terminal through a radio connection to a telecommunication system, and an improved network element of a telecommunication system.

According to an aspect of the invention, there is provided a wireless portable game terminal comprising: a radio transceiver configured to transfer speech and game data through a radio connection to a telecommunication system; a loudspeaker configured to reproduce audio; a microphone configured to capture speech of a user of the wireless portable game terminal; and a processing unit coupled to the radio transceiver, the loudspeaker and the microphone configured to process the game data, to transfer the game data to and from another game terminal or a game server through the radio connection, to receive captured speech of another user through the radio connection, to output audio part of the game data and the captured speech of the other user through the loudspeaker, to capture speech of an user with the microphone, and to transfer the captured speech of the user to another game terminal or to a game server through the radio connection.

According to another aspect of the invention, there is provided a method for transferring speech and game data to and from a wireless portable game terminal through a radio connection to a telecommunication system, the method comprising: capturing speech of a user of the wireless portable game terminal; transferring the captured speech of the user to another game terminal or to a game server through the radio connection; processing game data in the wireless portable game terminal; transferring the game data to and from another game terminal or a game server through a radio connection; receiving captured speech of another user through the radio connection; and reproducing audio part of the game data and the captured speech of the other user.

According to another aspect of the invention, there is provided a computer program product encoding a computer process for transferring speech and game data to and from a wireless portable game terminal through a radio connection to a telecommunication system, the process comprising: capturing speech of a user of the wireless portable game terminal; transferring the captured speech of the user to another game terminal or to a game server through the radio connection; processing game data in the wireless portable game terminal; transferring the game data to and from another game terminal or a game server through a radio connection; receiving captured speech of another user through the radio connection; and reproducing audio part of the game data and the captured speech of the other user.

According to another aspect of the invention, there is provided a network element of a telecommunication system comprising: a radio transceiver configured to transfer speech and game data in a radio connection; and a processing unit coupled to the radio transceiver, configured to transfer the speech and the game data to and from a wireless portable game terminal through the radio connection.

According to another aspect of the invention, there is provided a wireless portable game terminal comprising: radio transceiving means for transferring speech and game data through a radio connection to a telecommunication system; audio reproducing means for reproducing audio; speech capturing means for capturing speech of a user of the wireless portable game terminal; and processing means for processing the game data, for transferring the game data to and from another game terminal or a game server through the radio connection, for receiving captured speech of another user through the radio connection, for outputting audio part of the game data and the captured speech of the other user through the audio reproducing means, for capturing speech of an user with the speech capturing means, and for transferring the captured speech of the user to another game terminal or to a game server through the radio connection.

The invention provides several advantages. Real-time network gaming becomes possible. Both speech and game data may be transferred between game terminals, which are separated even by a large geographical distance.

### LIST OF DRAWINGS

In the following, the invention will be described in greater detail with reference to the embodiments and the accompanying drawings, in which

FIG. 1 is a simplified block diagram illustrating game terminals and a game server in connection with a telecommunication system:

FIG. 2 illustrates an embodiment of a telecommunication system;

FIG. 3 illustrates an embodiment of a wireless portable game terminal;

FIG. 4 illustrates an embodiment of a processing unit;

FIG. 5 illustrates an embodiment of a network element;

FIG. 6 illustrates an embodiment of protocol stacks; and

FIG. 7 is a flow diagram illustrating an embodiment of a method for transferring speech and game data.

### DESCRIPTION OF EMBODIMENTS

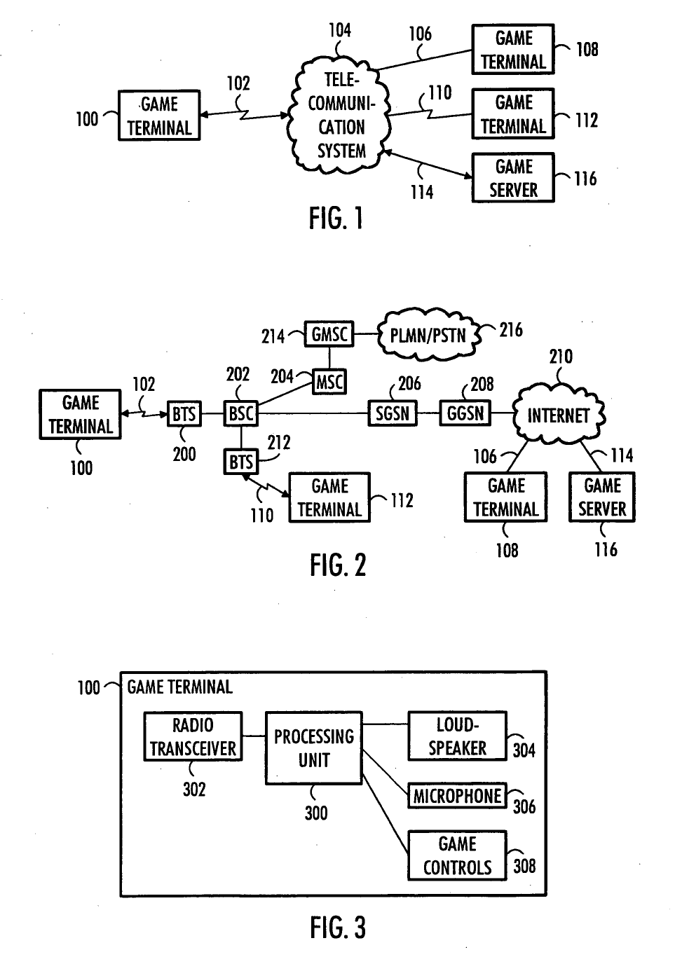

With reference to FIG. 1, examine an example of an environment whereto the embodiments of the invention can be applied. A wireless portable game terminal 100 communicates over a radio connection 102 through a telecommunication system 104 with other game terminals 108, 112 or a game server 116. The other game terminals 108, 112 may have a wired connection 106 or a wireless connection 110 to the telecommunication system 104. The connection 114 between the game server 116 and the telecommunication system 104 may be wired or wireless.

The game data may be processed in the game server 116. The game data may be transferred to the game terminals 100, 108, 112 participating in an on-going game. The game commands issued by the game terminal 100, 108, 112 user may be transferred to another game terminal 100, 108, 112 or to the game server 116. The game data may be updated on the basis of the received game commands in the game server in 116. Also speech of a player may be transferred between the game terminals 100, 108, 112. Speech of the player may include comments or commands to other players, for example.

An embodiment of the telecommunication system 104 is illustrated in FIG. 2. The telecommunication system 104 may comprise a pubiic switched telephone network (PSTN), one or more public land mobile networks (PLMN) and the Internet. Examples of the PLMN include GSM (Global System for Mobile Communications), GPRS (General Packet Radio System), and UMTS (Universal Mobile Telecommunications System). The embodiments are, however, not restricted to these systems described by way of example, but a person skilled in the art can also apply the instructions to other radio systems containing corresponding characteristics. The structure and functions of the network elements of the PLMN are not described in detail, because they are generally known. Further information on the radio system can, if necessary, be obtained in trade literature and standard specifications, for instance in Juha Korhonen: Introduction to 3G Mobile Communications, Artech House 2001, ISBN 1-58053-287-X.

The wireless portable game terminal 100 may have a radio connection 102 to a base transceiver station (BTS) 200. The other game terminal 112 may have a radio connection 110 to the same base transceiver station 200 or to another base transceiver station 212. A base station controller (BSC) 202 controls a number of base transceiver stations 200, 212. The base transceiver station may also be known by other names, such as node B. The base station controller may also be known by other names, such as a radio network controller.

From the base station controller 202 there is a connection to a mobile services switching center (MSC) 204. There may also be a separate gateway mobile services switching center (GMSC) 214, which takes care of circuit-switched connections to external networks 216, such as the PSTN or another PLMN.

A serving GPRS support node (SGSN) 206 and a gateway GPRS support node (GGSN) 208 may be used to implement packet-switched connections. Packet-switched connections may extend, via the gateway GPRS support node 208, over external networks, such as the Internet 210, to the other game terminal 108 and the game server 116.

FIG. 3 illustrates an embodiment of the wireless portable game terminal 100. The wireless portable game terminal 100 includes a radio transceiver 302 configured to transfer speech and game data through the radio connection 102 to the telecommunication system 104. The wireless portable game terminal 100 also includes a user interface. The user interface includes a loudspeaker 304 configured to reproduce audio and a microphone 306 configured to capture speech of a user of the wireless portable game terminal 100. The user interface may also include other elements, such as a screen and game controls 308. The game controls 308 may be part of the normal user interface of the terminal 100. A contemporary user interface may include buttons, keys, a joystick, a trackball, a touch screen or a normal screen, acceleration sensor based sensing of movements of the terminal, just to name a few. The user interface may, however, also be implemented in other ways known in the art of user interface design. It is well understood by the skilled person that a contemporary wireless portable game terminal 100 also includes numerous other structures, but as they are not necessary for illustrating the embodiments, they are not further described herein.

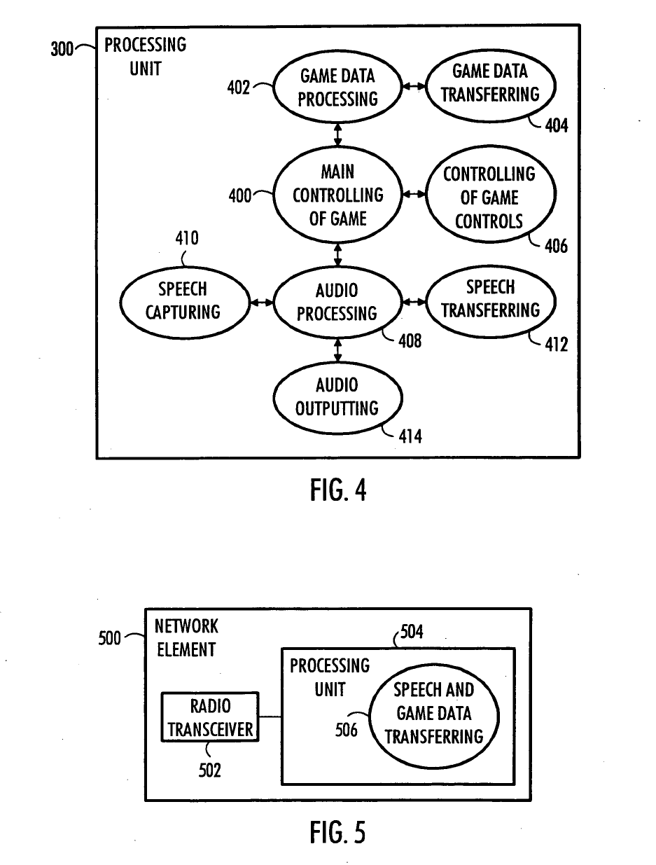

The wireless portable game terminal 100 also includes a processing unit 300 coupled to the radio transceiver 302, the loudspeaker 304, the microphone 306, and the game controls 308. FIG. 4 illustrates an embodiment of a processing unit. The processing unit 300 is configured to process 402 the game data, to transfer 404 the game data to and from another game terminal 108, 112 or a game server 116 through the radio connection 102, to receive 412 captured speech of another user through the radio connection 102, to output 414 audio part of the game data and the captured speech of the other user through the loudspeaker 304, to capture 410 speech of an user with the microphone 306, and to transfer 412 the captured speech of the user to another game terminal 108, 112 or to a game server 116 through the radio connection 102. The processing unit 300 may be configured to process the speech and the audio part of the game data in a separate entity 408. The processing unit 300 may also include an entity 400 responsible for the main controlling of a game currently played and an entity 406 responsible for the controlling of the game controls 308.

The term ‘processing unit’ has been used in the various embodiments presented above. Such a processing unit may be implemented in ways known in the art of computers and terminals. Implementation techniques include: one or more processors depending on the necessary processing power, one or more application-specific integrated circuits (ASIC), one or more integrated circuits (IC), one or more electronic circuits. In the processor, software that implements part of the desired functionality may be run. A combination of these different implementation techniques may also be used: the terminal may include one or more ASIC's for processing the communication signals and further, one or more microprocessors for processing game data. Specialized processors, for example for processing game data, may also be utilized. It is to be noted that this list of various implementation possibilities may not be exhaustive, but also other implementation techniques may be used.

If the terminal 100 is a subscriber terminal of the radio system, it may include a read/write unit where a SIM (Subscriber Identity Module) may be placed. The terminal 100 may also comprise another read/write unit that may accommodate an MMC (Multimedia Memory Card). The MMC may be used for storing a game and game data.

The wireless portable game terminal 100 may be a normal subscriber terminal, or then it may be a terminal especially adapted for gaming purposes, such as a Nokia® N-Gage™ game deck. A normal subscriber terminal may be called user equipment. Basically the user equipment comprises two parts: mobile equipment (ME) and UMTS subscriber identity module (USIM). The GSM system naturally uses its own identity module. The user equipment includes at least one transceiver for establishing a radio link. In addition, the user equipment contains an antenna, user interface and battery. Today, there are different types of user equipment, for instance equipment installed in cars and portable equipment. Properties better known from personal or portable computers have also been implemented in the user equipment. One example of this type of user equipment is Nokia® Communicator®. USIM contains information related to the user and information related to information security in particular, for instance an encryption algorithm.

As explained above, the telecommunication system 104 is used for transmitting speech and game data. Various resources of the telecommunication system may be used for speech and game data transferring. These resources will be described next.

In an embodiment the processing unit 300 and the transceiver 302 are further configured to transfer the game data as in-band signaling in a speech channel of the radio connection 102. The processing unit 300 may further be configured to transform the game data into Dual-Tone Multi-Frequency DTMF format or Teletype TTY format. The DTMF format has the advantage that it is designed for use with speech codecs, and therefore the game data may be more robust in the DTMF format against errors than in plain format.

In another embodiment the processing unit 300 and the transceiver 302 are further configured to transfer speech and the game data in a packet-switched data channel of the radio connection 102. The same packet-switched data channel may be used for both the speech and the game data transfer, which could induce savings.

In another embodiment the processing unit 300 and the transceiver 302 are further configured to transfer the speech and the game data in a circuit-switched data channel of the radio connection 102. Again, the same circuit switched data channel may be used for both the speech and the game data transfer, which could induce savings.

In another embodiment the radio connection comprises a Dual Transfer Mode DTM radio connection. DTM is a technology within the GSM/GPRS evolution towards the third generation systems with EDGE (Enhanced Data Rates for Global Evolution), with which it is possible to implement data and voice calls simultaneously. More information on DTM and the related standards can be found on the website of the 3rd Generation Partnership Project (3GPP); currently at the address www.3ggp.org.

In DTM, the subscriber terminal 100 is allocated radio resources providing a radio resources (RR) connection and a Temporary Block Flow TBF on one or more packet data physical channels. The processing unit 300 and the transceiver 302 may further be configured to transfer the game data utilizing a General Packet Radio Service Transparent Transport Protocol GTTP. The GTTP resource usually has free capacity to serve low data rates and the transfer delay is quite low (even as low as 100 milliseconds).

The use of the GTTP may necessitate some checks. The processing unit 300 may further be configured to check delay requirements of the game data, and to transfer the game data utilizing the GTTP, if the delay requirements meet a predetermined delay limit. The processing unit 300 may also be further configured to check the volume of the game data, and to transfer the game data utilizing GTTP, if the volume meets a predetermined volume limit. The processing unit 300 may also further be configured to check the block size of the game data, and to transfer the game data utilizing GTTP, if the block size meets a predetermined block size limit. The game data may include joystick movements, for example, which as such may need relatively little data transfer capacity, but which are time-critical part of a gaming application. Predetermined delay, volume and block size limits may be used to check whether the game data needs to be transferred fast as described, or whether fulfilling more relaxed requirements provides a good enough quality for the game. Game data may also be classified, so that for the Quality of Service class(es) with more stringent requirements the described embodiments may be used, whereas for the Quality of Service class(es) with less stringent requirements prior art transfer means may be used.

In an embodiment, the processing unit 300 and the transceiver 302 are further configured to transfer the game data utilizing a signaling resource of the DTM radio connection. Such a signaling resource comprises a Packet Flow Context PFC defined for the signaling. The PFC defined for signaling may have a Packet Flow Identifier PFI value 1. Normally PFI with value one is used for GMM/SM (GPRS Mobility Management/Session Management) signaling, so this necessitates a change in the specifications. However, such a change may be justified, considering that the signaling resource usually has quite a lot free capacity and that the delay is quite low (even as low as 100 milliseconds).

In another embodiment the processing unit 300 and the transceiver 302 are further configured to transfer the game data utilizing a gaming specific resource of the DTM radio connection. Such a gaming specific resource comprises a Packet. Flow Context PFC defined by gaming specific Quality of Service attributes. The gaming specific PFC may have a dedicated Packet Flow Identifier, which necessitates a change in the specifications. The gaming specific resource also comprises a Temporary Block Flow TBF defined by gaming specific Quality of Service attributes.

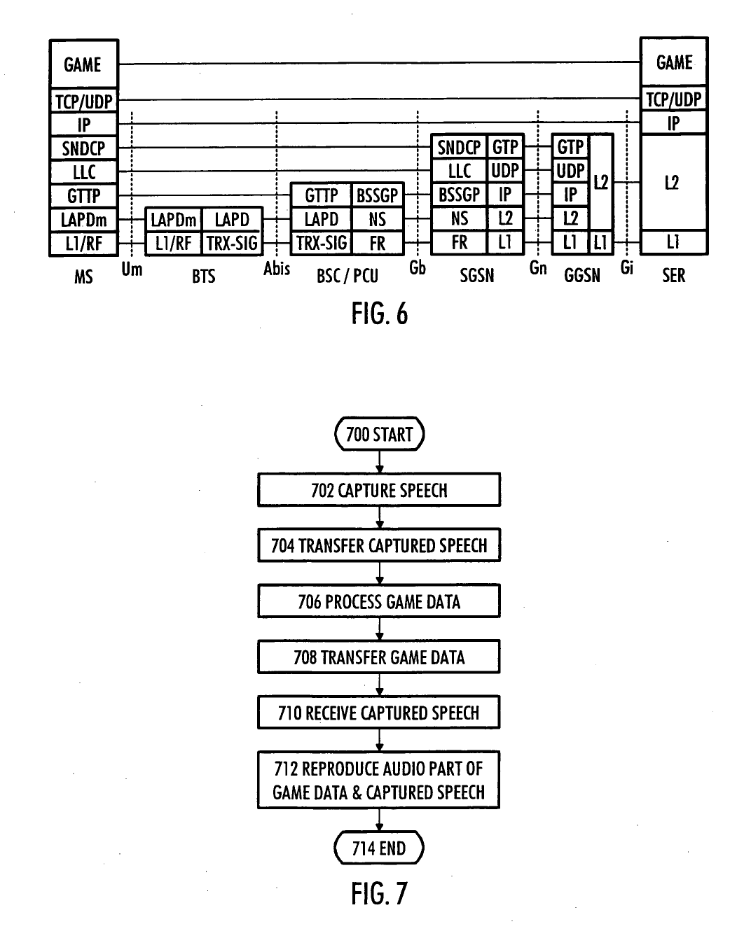

FIG. 6 illustrates an embodiment of protocol stacks. These protocol stacks may be used for transferring game data With the GTTP between the wireless portable game terminal 100 and the game server 116.

The terminal MS may include the following protocols: L1/RF (Layer 1/Radio Frequency), LAPDm (Link Access Protocol on the Dm channel), GTTP (GPRS Transparent Tunnelling Protocol), LLC (Logical link Control), SNDCP (Subnetwork Dependent Convergence Protocol), IP (Internet Protocol), TCP/UDP (Transmission Control Protocol/User Datagram Protocol) and game data protocol GAME. SNDCP may offer IP header compression, which could reduce the amount of data to one third, thus three kilobits per second could be reduced to one kilobit per second.

The base transceiver BTS may include the following protocols: towards the terminal L1/RF and LAPDm, and towards the base station controller TRX-SIG (Transceiver Signaling Channel) and LAPD (Link Access Protocol on the D channel).

The base station controller/packet control unit BSC/PCU may include the following protocols: towards the base station TRX-SIG, LAPD and GTTP, and towards the serving GRPS support node FR (Frame Relay), NS (Network Service) and BSSGP (Base Station System GPRS Protocol).

The serving GRPS support node SGSN may include the following protocols: towards the base station controller/packet control unit FR, NS, BSSGP, LLC and SNDCP, and towards the gateway GPRS support node L1 (Layer 1), L2 (Layer 2), IP, UDP and GTP (GPRS Tunnelling Protocol).

The gateway GPRS support node may include the following protocols: towards the serving GPRS support node L1, L2, IP, UDP and GTP, and towards a game server L1 and L2.

The game server SER may include the following protocols L1, L2, IP, TCP/UDP and the game data protocol GAME.

FIG. 6 also illustrates the following interfaces: Um interface between the terminal MS and the base transceiver station, Abis interface between the base transceiver station BTS and the base station controller/packet control unit BSC/PCU, Gb interface between the base station controller/packet control unit BSC/PCU and the serving GRPS support node SGSN, Gn interface between the serving GPRS support node SGSN and the gateway GPRS support node GGSN, and Gi interface between the gateway GPRS support node and the game server SER.

Next, with reference to FIG. 7, a method for transferring speech and game data to and from a wireless portable game terminal through a radio connection to a telecommunication system is described. The method starts in 700. Speech of a user of the wireless portable game terminal is captured in 702. Next, the captured speech of the user is transferred to another game terminal or to a game server through the radio connection in 704.

Game data is processed in the wireless portable game terminal in 706. Next, the game data is transferred to and from another game terminal or a game server through a radio connection in 708.

Captured speech of another user is received through the radio connection in 710. Next, audio part of the game data and the captured speech of the other user are reproduced in 712.

The method ends in 714. The environment described above may be used for implementing the method, but the method may also be applied to other environments where speech and game data may be transferred to and from a wireless portable game terminal through a radio connection to a telecommunication system.

Various resources of the telecommunication system may be used for speech and game data transferring. In an embodiment, the method further comprises: transferring the game data as in-band signaling in a speech channel of the radio connection. In another embodiment, the method further comprises: transferring the speech and the game data in a packet-switched data channel of the radio connection. In another embodiment, the method further comprises: transferring the speech and the game data in a circuit-switched data channel of the radio connection.

In an embodiment, the radio connection comprises a Dual Transfer Mode DTM radio connection. In an embodiment, the method further comprises: transferring the game data utilizing a General Packet Radio Service Transparent Transport Protocol GTTP.

The use of the GTTP may necessitate some checks. In an embodiment, the method further comprises: checking delay requirements of the game data, and transferring the game data utilizing the GTTP, if the delay requirements meet a predetermined delay limit. In another embodiment, the method further comprises: checking the volume of the game data, and transferring the game data utilizing GTTP, if the volume meets a predetermined volume limit. In another embodiment, the method further comprises: checking the block size of the game data, and transferring the game data utilizing GTTP, if the block size meets a predetermined block size limit.

In an embodiment, the method further comprises: transferring the game data utilizing a signaling resource of the DTM radio connection. In an embodiment, the signaling resource comprises a Packet Flow Context PFC defined for the signaling.

In another embodiment the method further comprises: transferring the game data utilizing a gaming specific resource of the DTM radio connection. In an embodiment the gaming specific resource comprises a Packet Flow Context PFC defined by gaming specific Quality of Service attributes. In an embodiment the gaming specific resource comprises a Temporary Block Flow TBF defined by gaming specific Quality of Service attributes.

An embodiment provides for a computer program product encoding a computer process for transferring speech and game data to and from a wireless portable game terminal through a radio connection to a telecommunication system, the process implementing the above-described method. The computer program product may be embodied on a computer program distribution medium. The computer program distribution medium includes all ways known in the art for distributing software, such as a computer readable medium, a program storage medium, a record medium, a computer readable memory, a computer readable software distribution package, a computer readable signal, a computer readable telecommunication signal, and a computer readable compressed software package.

As illustrated in FIG. 5, an embodiment provides for a network element 500 of a telecommunication system. The network element 500 includes a radio transceiver 502 configured to transfer speech and game data in a radio connection, and a processing unit 504 coupled to the radio transceiver 502, configured to transfer 506 the speech and the game data to and from a wireless portable game terminal through the radio connection. Some of the embodiments, explained above for the wireless portable game terminal 100, apply as well for the network element 500, as evidenced by the appended claims.

Even though the invention is described above with reference to an example according to the accompanying drawings, it is clear that the invention is not restricted thereto but it can be modified in several ways within the scope of the appended claims.

1. A wireless portable game terminal comprising:
a radio transceiver configured to transfer speech and game data through a radio connection to a telecommunication system;
a loudspeaker configured to reproduce audio;
a microphone configured to capture speech of a user of the wireless portable game terminal; and
a processing unit coupled to the radio transceiver, the loudspeaker and the microphone configured to process the game data, to transfer the game data to and from another game terminal or a game server through the radio connection, to receive captured speech of another user through the radio connection, to output audio part of the game data and the captured speech of the other user through the loudspeaker, to capture speech of an user with the microphone, and to transfer the captured speech of the user to another game terminal or to a game server through the radio connection.

2. The wireless portable game terminal of claim 1, wherein the processing unit and the transceiver are further configured to transfer the game data as in-band signaling in a speech channel of the radio connection.

3. The wireless portable game terminal of claim 1, wherein the processing unit and the transceiver are further configured to transfer speech and the game data in a packet-switched data channel of the radio connection.

4. The wireless portable game terminal of claim 1, wherein the processing unit and the transceiver are further configured to transfer the speech and the game data in a circuit-switched data channel of the radio connection.

5. The wireless portable game terminal of claim 1, wherein the radio connection comprises a Dual Transfer Mode DTM radio connection.

6. The wireless portable game terminal of claim 5, wherein the processing unit and the transceiver are further configured to transfer the game data utilizing a General Packet Radio Service Transparent Transport Protocol Gttp:.

7. The wireless portable game terminal of claim 6, wherein the processing unit is further configured to check delay requirements of the game data, and to transfer the game data utilizing the GTTP, if the delay requirements meet a predetermined delay limit.

8. The wireless portable game terminal of claim 6, wherein the processing unit is further configured to check the volume of the game data, and to transfer the game data utilizing GTTP, if the volume meets a predetermined volume limit.

9. The wireless portable game terminal of claim 6, wherein the processing unit is further configured to check the block size of the game data, and to transfer the game data utilizing GTTP, if the block size meets a predetermined block size limit.

10. The wireless portable game terminal of claim 6, wherein the processing unit and the transceiver are further configured to transfer the game data utilizing a signaling resource of the DTM radio connection.

11. The wireless portable game terminal of claim 10, wherein the signaling resource comprises a Packet Flow Context PFC defined for the signaling.

12. The wireless portable game terminal of claim 5, wherein the processing unit and the transceiver are further configured to transfer the game data utilizing a gaming specific resource of the DTM radio connection.

13. The wireless portable game terminal of claim 12, wherein the gaming specific resource comprises a Packet Flow Context PFC defined by gaming specific Quality of Service attributes.

14. The wireless portable game terminal of claim 12, wherein the gaming specific resource comprises a Temporary Block Flow TBF defined by gaming specific Quality of Service attributes.

15. A method for transferring speech and game data to and from a wireless portable game terminal through a radio connection to a telecommunication system, the method comprising:
capturing speech of a user of the wireless portable game terminal;
transferring the captured speech of the user to another game terminal or to a game server through the radio connection;
processing game data in the wireless portable game terminal;
transferring the game data to and from another game terminal or a game server through a radio connection;
receiving captured speech of another user through the radio connection; and
reproducing audio part of the game data and the captured speech of the other user.

16. The method of claim 15, wherein the method further comprises:
transferring the game data as in-band signaling in a speech channel of the radio connection.

17. The method of claim 15, wherein the method further comprises:
transferring the speech and the game data in a packet-switched data channel of the radio connection.

18. The method of claim 15, wherein the method further comprises:
transferring the speech and the game data in a circuit-switched data channel of the radio connection.

19. The method of claim 15, wherein the radio connection comprises a Dual Transfer Mode DTM radio connection.

20. The method of claim 19, wherein the method further comprises:
transferring the game data utilizing a General Packet Radio Service Transparent Transport Protocol GTTP.

21. The method of claim 20, wherein the method further comprises:
checking delay requirements of the game data; and
transferring the game data utilizing the GTTP, if the delay requirements meet a predetermined delay limit.

22. The method of claim 20, wherein the method further comprises:
checking the volume of the game data; and
transferring the game data utilizing GTTP, if the volume meets a predetermined volume limit.

23. The method of claim 20, wherein the method further comprises:
checking the block size of the game data; and
transferring the game data utilizing GTTP, if the block size meets a predetermined block size limit.

24. The method of claim 20, wherein the method further comprises:
transferring the game data utilizing a signaling resource of the DTM radio connection.

25. The method of claim 24, wherein the signaling resource comprises a Packet Flow Context PFC defined for the signaling.

26. The method of claim 19, wherein the method further comprises:
transferring the game data utilizing a gaming specific resource of the DTM radio connection.

27. The method of claim 26, wherein the gaming specific resource comprises a Packet Flow Context PFC defined by gaming specific Quality of Service attributes.

28. The method of claim 26, wherein the gaming specific resource comprises a Temporary Block Flow TBF defined by gaming specific Quality of Service attributes.

29. A computer program product encoding a computer process for transferring speech and game data to and from a wireless portable game terminal through a radio connection to a telecommunication system, the process comprising:
capturing speech of a user of the wireless portable game terminal;
transferring the captured speech of the user to another game terminal or to a game server through the radio connection;
processing game data in the wireless portable game terminal;
transferring the game data to and from another game terminal or a game server through a radio connection;
receiving captured speech of another user through the radio connection; and
reproducing audio part of the game data and the captured speech of the other user.

30. A network element of a telecommunication system comprising:
a radio transceiver configured to transfer speech and game data in a radio connection; and
a processing unit coupled to the radio transceiver, configured to transfer the speech and the game data to and from a wireless portable game terminal through the radio connection.

31. The network element of claim 30, wherein the processing unit and the transceiver are further configured to transfer the game data as in-band signaling in a speech channel of the radio connection.

32. The network element of claim 30, wherein the processing unit and the transceiver are further configured to transfer speech and the game data in a packet-switched data channel of the radio connection.

33. The network element of claim 30, wherein the processing unit and the transceiver are further configured to transfer the speech and the game data in a circuit-switched data channel of the radio connection.

34. The network element of claim 30, wherein the radio connection comprises a Dual Transfer Mode DTM radio connection.

35. The network element of claim 34, wherein the processing unit and the transceiver are further configured to transfer the game data utilizing a General Packet Radio Service Transparent Transport Protocol GTTP.

36. The network element of claim 35, wherein the processing unit is further configured to check delay requirements of the game data, and to transfer the game data utilizing the GTTP, if the delay requirements meet a predetermined delay limit.

37. The network element of claim 35, wherein the processing unit is further configured to check the volume of the game data, and to transfer the game data utilizing GTTP, if the volume meets a predetermined volume limit.

38. The network element of claim 35, wherein the processing unit is further configured to check the block size of the game data, and to transfer the game data utilizing GTTP, if the block size meets a predetermined block size limit.

39. The network element of claim 35, wherein the processing unit and the transceiver are further configured to transfer the game data utilizing a signaling resource of the DTM radio connection.

40. The network element of claim 39, wherein the signaling resource comprises a Packet Flow Context PFC defined for the signaling.

41. The network element of claim 34, wherein the processing unit and the transceiver are further configured to transfer the game data utilizing a gaming specific resource of the DTM radio connection.

42. The network element of claim 41, wherein the gaming specific resource comprises a Packet Flow Context PFC defined by gaming specific Quality of Service attributes.

43. The network element of claim 41, wherein the gaming specific resource comprises a Temporary Block Flow TBF defined by gaming specific Quality of Service attributes.

44. A wireless portable game terminal comprising:
radio transceiving means for transferring speech and game data through a radio connection to a telecommunication system;
audio reproducing means for reproducing audio;
speech capturing means for capturing speech of a user of the wireless portable game terminal; and
processing means for processing the game data, for transferring the game data to and from another game terminal or a game server through the radio connection, for receiving captured speech of another user through the radio connection, for outputting audio part of the game data and the captured speech of the other user through the audio reproducing means, for capturing speech of an user with the speech capturing means, and for transferring the captured speech of the user to another game terminal or to a game server through the radio connection.
